(19) United States
(12) Patent Application Publication
(10) Pub. No.: US 2020/0050757 A1
(43) Pub. Date: Feb. 13, 2020

(54) ACTION MONITORING APPARATUS, SYSTEM, AND METHOD

(71) Applicant: NEC Corporation, Tokyo (JP)

(72) Inventors: Kentaro SONODA, Tokyo (JP); Kayato SEKIYA, Tokyo (JP)

(73) Assignee: NEC Corporation, Tokyo (JP)

(21) Appl. No.: 16/656,735

(22) Filed: Oct. 18, 2019

Related U.S. Application Data
(63) Continuation of application No. 16/344,485, filed on Apr. 24, 2019.

(51) Int. Cl. G06F 21/55; G08B 23/00; G07C 9/00

(52) U.S. Cl. CPC G06F 21/55; G07C 9/00; G08B 23/00

(57) ABSTRACT

Action instruction information includes action procedure information. The action procedure information defines an action procedure of a person including a plurality of action steps. Log information is information with respect to access to an object to be monitored and is acquired from a security apparatus for monitoring the object to be monitored. An action trace unit traces advance of the action step in the action procedure based on the action instruction information and the log information. A trace display unit associates the advance of the action step with access to the security apparatus based on the log information and the advance of the action step traced by the action trace unit and displays them on a display device.

The present application is a Continuation application of Ser. No. 16/344,485 filed on Apr. 24, 2019, which is a National Stage Entry of PCT/JP2016/004765 filed on Oct. 31, 2016, the contents of all of which are incorporated herein by reference, in their entirety.

### TECHNICAL FIELD

The present disclosure relates to an action monitoring apparatus, system, method, and program, more particularly, to an action monitoring apparatus, system, method, and program for monitoring actions of a worker.

### BACKGROUND ART

In recent years, security crimes have increased in social infrastructure businesses such as electricity, gas, and water supply, and in systems for them. Security crimes may be carried out by an insider such as a worker performing, for example, maintenance. For example, there may be a case in which a worker goes to a facility such as a substation to perform maintenance, steals materials in the facility, and sells them to get money. Sometimes, there may a case in which a worker receives a request from a malicious third party and steals information from a PC (Personal Computer) or a server operating inside of a facility, or connects a USB (Universal Serial Bus) memory having a wireless communication function to the PC or the server without permission.

In order to prevent the above crimes, various security systems for performing management of entry and exit of workers or management of login IDs (Identifiers) for PCs or servers are used. The security systems are roughly classified into physical security systems and cyber security systems. The physical security systems include a system for performing entry and exit management and a system for performing monitoring by a monitoring camera. The cyber security systems include an intrusion detection system or the like using access control to PCs or servers or packet analysis within them. The social infrastructure operators individually manage and operate (monitor) these security systems.

With respect to the security systems, Patent Literature 1 discloses a technique for detecting crimes by an insider taking both the physical security system and the cyber security system into consideration. In this context, the insider indicates an in-house person possessing privileges. Crimes of a malicious insider cannot be detected by only referring to logs of the cyber security system. In order to detect a crime, it is necessary to also refer to logs of the physical security system, for example, a location of access when a PC or the like is accessed. The technique disclosed in Patent Literature 1 detects suspicious actions or behavior in both the physical security system and the cyber security system using machine learning.

Further, Patent Literature 2 discloses a technique for automatically associating event logs of the security systems with related persons (workers). The technique disclosed in Patent Literature 2 associates badges of workers with IDs, assigns the IDs to events and alarms that can occur in all security systems, and manages them. Further, in Patent Literature 2, control rules such as ‘when an area where it is not permitted to enter is intruded into, disabling access to a PC or the like’ or ‘when a PC to which login is not permitted is accessed, making a door for accessing the area around it not unlocked (locked), and activating a monitoring camera’ are prepared and monitoring is carried out using these control rules.

### CITATION LIST

### Patent Literature

[Patent Literature 1] U.S. Pat. No. 8,793,790
[Patent Literature 1] U.S. Pat. No. 7,380,279

### SUMMARY OF INVENTION

### Technical Problem

However, in the above Patent Literature 1 and 2, there is a problem that it is not possible to detect suspicious actions of a worker to whom a legitimate ID is given as described below. In this context, the suspicious actions of the worker include one of, or both of suspicious actions such as, for example, repeatedly entering and leaving a specific room, which can be detected using the physical security system, and suspicious actions such as, for example, executing a command not necessary for his/her work, which can be detected using cyber security system.

According to the technique disclosed in Patent Literature 1, it is possible to detect an extraordinary action of the worker using machine learning. However, in the Patent Literature 1, a series of actions of the worker extending over the physical security system and the cyber security system is not traced. Accordingly, in the technique disclosed in Patent Literature 1, it is difficult for a supervisor to accurately know whether actions of the worker fall within a normal operation range or not, and thus it is not possible to detect suspicious actions of a worker to whom a legitimate ID is given.

On the other hand, according to the technique disclosed in Patent Literature 2, by registering access control rules in which actions in the physical security system and actions in the cyber security system are mixed, monitoring extending over both systems can be realized. However, in Patent Literature 2, although it is possible to register rules with specific actions as conditions, there is a possibility that other actions cannot be detected. Accordingly, even in the technique disclosed in Patent Literature 2, it is not possible to detect suspicious actions of a worker to whom a legitimate ID is given.

In view of the above-described circumstances, an object of the present disclosure is to provide an action monitoring apparatus, system, method, and program capable of detecting a suspicious action of a worker.

### Solution to Problem

In order to address the above problem, the present disclosure provides an action monitoring apparatus comprising:

an action trace unit for tracing, based on action instruction information including action procedure information which defines an action procedure of a person including a plurality of action steps and log information with respect to access to an object to be monitored, the log information being acquired from a security apparatus for monitoring the object to be monitored, advance of the action step in the action procedure; and

a trace display unit for associating the advance of the action step with access to the security apparatus based on the log information and the traced advance of the action step, and displaying them on a display device.

Further the present disclosure provides an action monitoring system comprising:

a security apparatus for monitoring an object to be monitored;

a log acquisition unit for acquiring log information with respect to access to the object to be monitored from the security apparatus;

an action trace unit for tracing, based on the log information and action instruction information including action procedure information which defines an action procedure of a person including a plurality of action steps, advance of the action step in the action procedure; and

a trace display unit for associating the advance of the action step with access to the security apparatus and displaying them on a display device.

Furthermore, the present disclosure provides an action monitoring method comprising:

acquiring log information with respect to access to an object to be monitored from a security apparatus for monitoring the object to be monitored;

tracing, based on the log information and action instruction information including action procedure information which defines an action procedure of a person including a plurality of action steps, advance of the action step in the action procedure; and

associating the advance of the action step with access to the security apparatus and displaying them on a display device.

Further, the present disclosure provides a program for causing a computer to execute steps of:

acquiring log information with respect to access to an object to be monitored from a security apparatus for monitoring the object to be monitored;

tracing, based on the log information and action instruction information including action procedure information which defines an action procedure of a person including a plurality of action steps, advance of the action step in the action procedure; and

associating the advance of the action step with access to the security apparatus and displaying them on a display device

### Advantageous Effects of Invention

An action monitoring apparatus, system, method, and program according to the present disclosure can detect a suspicious action of a worker.

### BRIEF DESCRIPTION OF DRAWINGS

FIG. 1 is a block diagram showing an action monitoring apparatus according to the present disclosure.

FIG. 2 is a block diagram showing an action monitoring system including an action monitoring apparatus according to an embodiment of the present disclosure.

FIG. 3 is a diagram showing a specific example of action procedure information.

FIG. 4 is a diagram shown a specific example of access control information.

FIG. 5 is a diagram showing a relationship between an action procedure and access control.

FIG. 6 is a diagram showing an example of an edit screen displayed when the information is generated and edited.

FIG. 7 is a diagram showing a log stored in a log storage unit as action steps advance.

FIG. 8 is a flow chart showing an operation procedure in monitoring of a worker.

FIG. 9 is a diagram showing an example of a monitor screen.

FIG. 10 is a diagram showing a first example of a display screen of the monitor screen.

FIG. 11 is a diagram showing a second example of a display screen of the monitor screen.

FIG. 12 is a diagram showing a third example of a display screen of the monitor screen.

### DESCRIPTION OF EMBODIMENTS

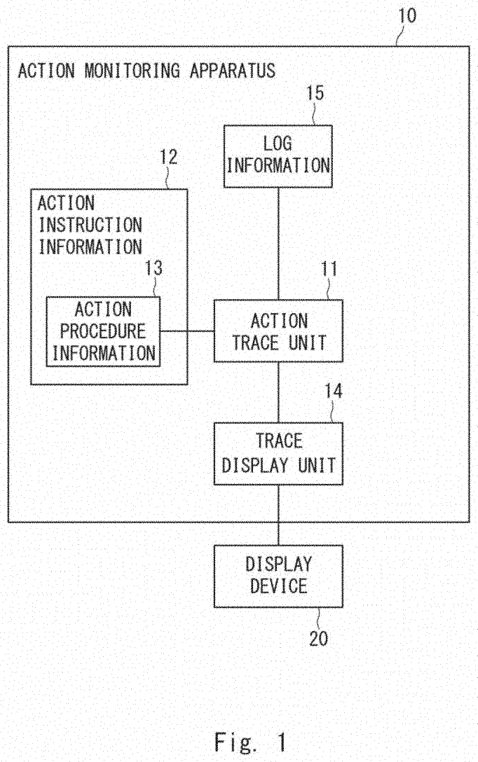

Prior to explain embodiments of the present disclosure, an outline of the present disclosure will be described. FIG. 1 shows an action monitoring apparatus according to the present disclosure. An action monitoring apparatus 10 includes an action trace unit 11 and a trace display unit 14. The action monitoring apparatus 10 is configured, for example, using a computer apparatus. The action monitoring apparatus 10 typically includes a processor and a memory. Functions of the action trace unit 11 and the trace display unit 14 may be implemented by the processor executing processes in accordance with programs read out from the memory.

The action trace unit 11 refers to action instruction information 12 and log information 15. The action instruction information 12 includes action procedure information 13. The action procedure information 13 defines an action procedure of a person including a plurality of action steps (action phases). The log information 15 is acquired from a security apparatus which monitors an object to be monitored. The log information 15 includes a log with respect to access to an apparatus or a system to be monitored. The action instruction information 12 and log information 15 are respectively stored in, for example, an auxiliary storage device such as a hard disk drive or a memory. The action trace unit 11 traces advance of the action step in the action procedure defined by action procedure information 13 based on the action instruction information 12 and the log information 15.

The trace display unit 14 associates the advance of the action step with access to the security apparatus based on the log information 15 the advance of the action step traced by the action trace unit 11 and displays them on the display device 20. By displaying the action step of a worker and the access to the security apparatus on the display device 20, it is possible for a supervisor to check what actions the worker carried out in the action procedure defined in the action procedure information 13. Accordingly, the supervisor can determine whether actions of the worker fall within a range of normal operation or not, and thus it is possible to detect suspicious actions of the worker who has a legitimate ID.

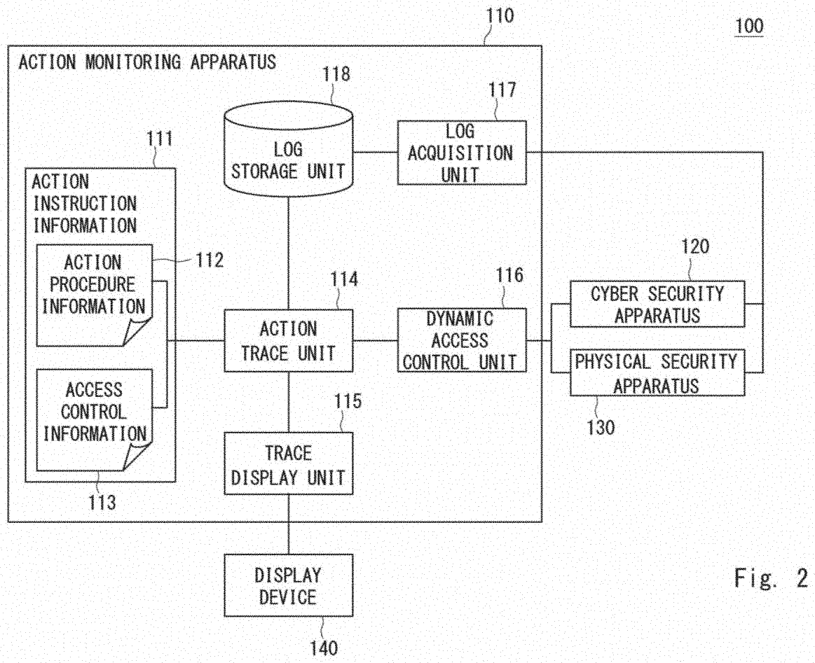

Hereinafter, embodiments of the present disclosure will be described in detail with reference to figures. FIG. 2 shows an action monitoring system including an action monitoring apparatus according to a first embodiment of the present disclosure. An action monitoring system 100 includes an action monitoring apparatus 110, a cyber security apparatus 120, and a physical security apparatus 130. The action monitoring apparatus 110 corresponds to the action monitoring apparatus 10 shown in FIG. 1.

The cyber security apparatus 120 is an apparatus (system), for example, configured to take actions to prevent unauthorized activities to a computer to be monitored. The cyber security apparatus 120 includes devices and software with respect to cyber security. The cyber security apparatus 120 includes, for example, at least one of a firewall, an illegal intrusion detection system, and an illegal intrusion protection system.

The physical security apparatus 130 is an apparatus (system) configured to prevent physical access to a facility or information to be monitored, damage, and interference. The physical security apparatus 130 includes devices and software with respect to physical security. The physical security apparatus 130 includes, for example, at least one of a system for door management and a monitoring camera system. More specifically, the physical security apparatus 130 includes a card reader installed at a doorway of a room and a mechanism for controlling locking and unlocking of a door in accordance with a result of authentication. Further, the physical security apparatus 130 includes a monitoring camera, an image server for storing images recorded by the monitoring camera, and a mechanism for controlling a photographing direction of the monitoring camera.

The action monitoring apparatus 110 includes an action trace unit 114, a trace display unit 115, an access control unit 116, a log acquisition unit 117, and a log storage unit 118. The action monitoring apparatus 110 is configured, for example, using a computer apparatus. The action monitoring apparatus 110 typically includes a processor and a memory. Functions of each unit in the action monitoring apparatus 110 may be implemented by the processor executing processes in accordance with programs read out from the memory.

The action instruction information 111 includes action procedure information 112 and access control information 113. The action procedure information 112 is information describing an action procedure of a person (worker) who performs a work. The action procedure information 112 defines the action procedure of the worker including a plurality of action steps. The access control information 113 is information describing access control to the cyber security apparatus 120 and the physical security apparatus 130. The action instruction information 111 is stored in a not-shown storage device. The action procedure information 112 and the access control information 113 may be stored in the same file or in separate files. The action instruction information 111 and the action procedure information 112 respectively correspond to the action instruction information 12 and the action procedure information 13 shown in FIG. 1.

The log acquisition unit 117 acquires logs with respect to access to object to be monitored from the cyber security apparatus 120 and the physical security apparatus 130. The log acquisition unit 117 stores the acquired logs as log information in the log storage unit 118. The log storage unit 118 is configured as, for example, an auxiliary storage device such as a hard disk drive. The log information stored in the log storage unit 118 includes a log indicating that access is permitted and a log indicating that access is denied. The log information stored in the log storage unit 118 corresponds to the log information 15 shown in FIG. 1.

The log acquisition unit 117 acquires, for example from the cyber security apparatus 120, a log (event log) indicating that data are copied in a computer, and stores the log in the log storage unit 118. Further, the log acquisition unit 117 acquires, for example from the physical security apparatus 130, an event log, with respect to the monitoring camera, indicating that a person enters an invasion prohibited area, and stores the event log in the log storage unit 118. In the present description, for convenience, among event logs, an event log indicating that a predetermined action is performed is considered as the log indicating that access is permitted. Further, an event log indicating occurrence of an abnormal event such as intrusion of a person into invasion prohibited area is considered as the log indicating that access is denied.

The action trace unit 114 traces advance of the action step in the action procedure defined by the action procedure information 112 based on the log information stored in the log storage unit 118 and the action procedure information 112 included in the action instruction information 111. The action trace unit 114 shifts the action step to the next action step when a log indicating specific access defined as a transition condition from an action step to another action step in the action procedure is included in the log information. The action trace unit 114 corresponds to the action trace unit 11 shown in FIG. 1.

The trace display unit 115 associates the advance of the action step and access to the cyber security apparatus 120 and the physical security apparatus 130 based on the log information and the advance of the action step of the worker traced by the action trace unit 114, and displays them on the display device 140. For example, the trace display unit 115 displays, as action trace, the advance of the action step and the access to the cyber security apparatus 120 and the physical security apparatus 130 in chronological order. The trace display unit 115 corresponds to the trace display unit 14 shown in FIG. 1.

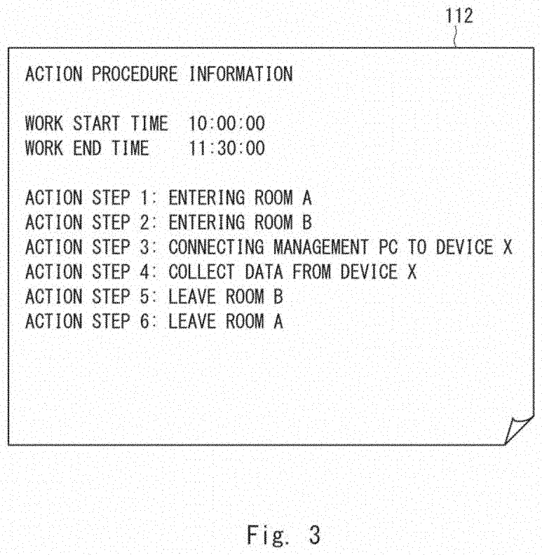

FIG. 3 shows a specific example of the action procedure information 112. The action procedure information 112 includes, for example, information regarding the work start time and the work end time. In the example shown in FIG. 3, the action procedure of the worker includes six action steps. The action step 1 is ‘entering the room A’, and the action step 2 is ‘entering the room B”. The action step 3 is ‘connecting a management PC to the device X’, and the action step 4 is ‘collect data from the device X’. The action step 5 is ‘leave the room B’, and the action step 6 is ‘leave the room A’. The worker carries out the work in accordance with the action procedure including the series of action steps as such.

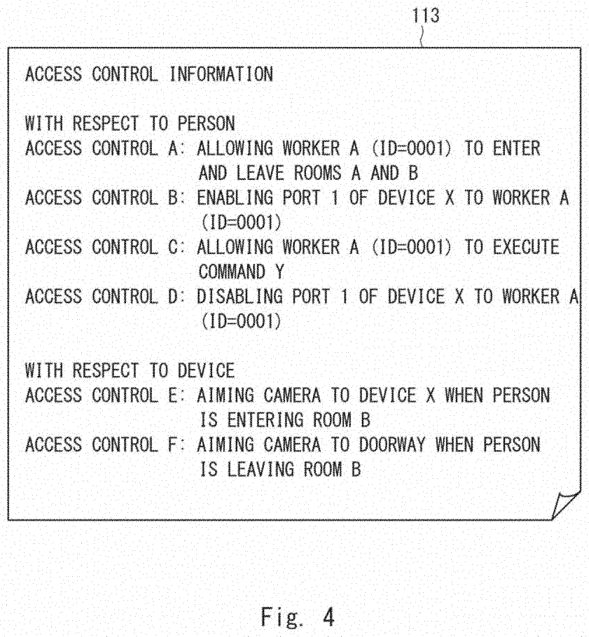

FIG. 4 shows a specific example of the access control information 113. The access control information 113 includes, for example, the access control A to D with respect to actions of a person (worker) and the access control E and F with respect to a device. The access control A is for allowing the worker A given ID ‘0001’ to enter and leave from the rooms A and B, and the access control B is for enabling the port 1 of the device X to the worker A. The access control C is for allowing the worker A to execute the command Y on the device X, and the access control D is for disabling the port 1 of device X to the worker A.

Further, the access control E is for aiming the camera to the device X when a person is entering the room B, and the access control F is for aiming the camera to doorway when a person is leaving from the room B. The access control A, E, and F define the contents of the access control with respect to the physical security apparatus 130, and the access control B to D define the contents of the access control with respect to the cyber security apparatus 120. It should be noted that, the access control with respect to the worker may designate, as the ID of the worker to whom the content of the access control is applied, only one ID, or a plurality of IDs corresponding to a plurality of workers. Further, in the access control, ‘All’ may be designated as the ID of the worker to whom the content of the access control is applied such that the access control is to be applied to all the workers.

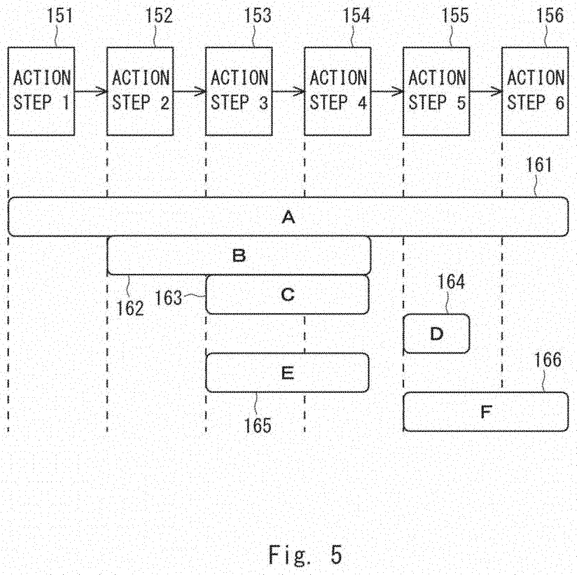

FIG. 5 shows relationship between the action procedure defined by the action instruction information 112 and the access control defined by the access control information 113. The action steps 151 to 156 shown in FIG. 5 correspond to the action steps 1 to 6 of the action procedure information 112 shown in FIG. 3. Further, the access control 161 to 166 shown in FIG. 5 correspond to the access control A to F of access control information 113 shown in FIG. 4.

The access control information 113 includes information associating the content of the access control with the action step in which the content of the access control is applied. In the example of FIG. 5, the access control 161 is applied during the action step 151 to the action step 156, and the access control 162 is applied during the action step 152 to action step 154. The access control 163 and 165 are applied at the action step 153 and the action step 154, the access control 164 is applied at the action step 155, and the access control 166 is applied at action step 155 and the action step 156.

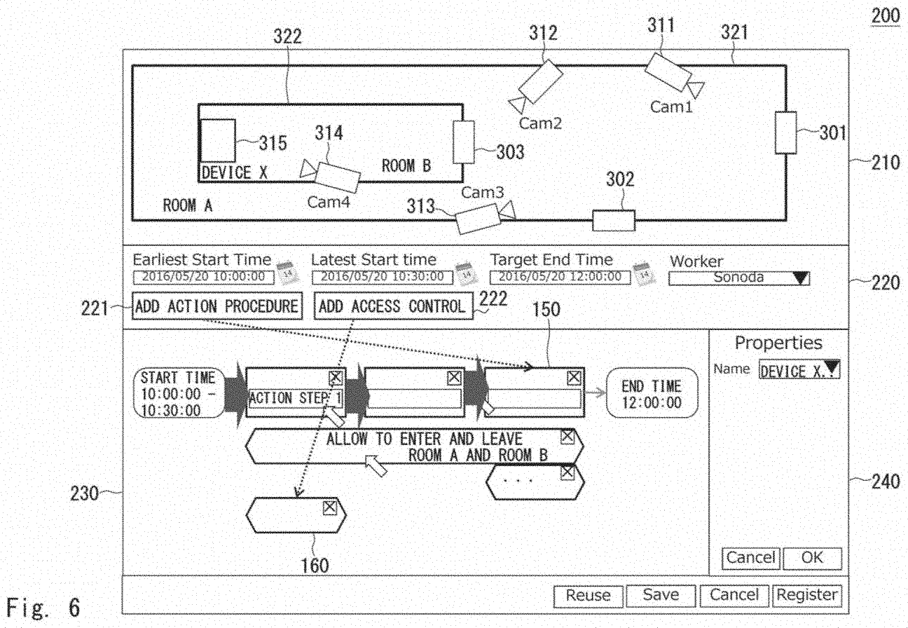

The action procedure information 112 and the access control information 113 may be created or edited using a not-shown information creation unit provided in the action monitoring apparatus 110. FIG. 6 shows an example of a screen (edit screen) displayed on the display device 140 when the action procedure information 112 and the access control information 113 are created and edited. An edit screen 200 shown in FIG. 6 roughly includes four areas 210, 220, 230, and 240.

The area 210 is an area where arrangement of devices and the like is displayed. In the area 210, devices and the like to be monitored by the cyber security apparatus 120 and the physical security apparatus 130 are displayed on a map. In FIG. 6, it is assumed that a room 321 illustrated in the area 210 corresponds to the ‘room A’ and a room 322 corresponds to the ‘room B’. There are two doorways (doors) with the room 321 and card readers 301 and 302 are installed at the inside and the outside of each door respectively. There is a doorway (door) with the room 322 and a card reader 303 is installed at the inside and the outside of the door.

Further, in FIG. 6, three monitoring cameras 311 to 313 are installed in the room 321. In the room 322, a monitoring camera 314 and a device 315 are installed. The device 315 is a device corresponding to the ‘device X’. Information security of the device 315 is protected using the cyber security apparatus 120.

It should be noted that the card readers 301 to 303, and the monitoring cameras 311 to 314 constitute a portion of the physical security apparatus 130. The worker passes his/her own ID card or the like to the card reader 301 or 302 when entering or leaving the room 321. The physical security apparatus 130 acquires the ID from the card readers 301 and 302 and performs authentication. The physical security apparatus 130 unlocks the door if the worker is authorized to enter the room 321 and leave the room 321. If the worker is not authorized, the physical security apparatus 130 maintain the door locked. The physical security apparatus 130 outputs logs such as the ID read by the card readers 301 and 302 and the authentication result to the log acquisition unit 117 (refer to FIG. 2).

In similar way, the worker passes his/her own ID card or the like to the card reader 303 when entering and leaving the room 322. The physical security apparatus 130 acquires the ID from the card reader 303 and performs authentication. The physical security apparatus 130 unlocks the door if the worker is authorized to enter the room 322 and leave from the room 322. If the worker is not authorized, the physical security apparatus 130 maintain the door locked. The physical security apparatus 130 outputs logs such as the ID read by the card readers 303 and the authentication result to the log acquisition unit 117.

The monitoring cameras 311 to 314 are installed, for example, on the ceiling. The physical security apparatus 130 controls the monitoring cameras 311 to 314 and controls start and stop of the image recording. At least one of the monitoring cameras 311 to 314 may be configured such that the photographing direction can be controlled using a motor or the like. In this case, the physical security apparatus 130 may control the photographing direction. Images taken using the monitoring cameras 311 to 314 are stored in a storage device provided in a not-shown image server. Alternatively, the taken images may be stored in the log storage unit 118 through the log acquisition unit 117.

The areas 220, 230, and 240 are areas relating to creating and editing the action procedure information 112 and the access control information 113. The area 220 includes portions in which the start time and the end time of the work and the name of the worker are input. In addition, the area 220 includes a button 221 for adding an action step of the action procedure defined by the action procedure information 112, and a button 222 for adding access control defined by the access control information 113.

The area 230 is an area in which the action procedure information 112 and the access control information 113 being created or being edited are graphically displayed. When the supervisor or the like selects the button 221 in the area 220, a new action step 150 is added in the area 230. Further, when the supervisor or the like selects the button 222, new access control 160 is added in the area 230. The contents of the action step 150 and the access control 160 can be designate in the area 240. The supervisor can create the action instruction information 111 including the action procedure information 112 and the access control information 113 through the edit screen 200.

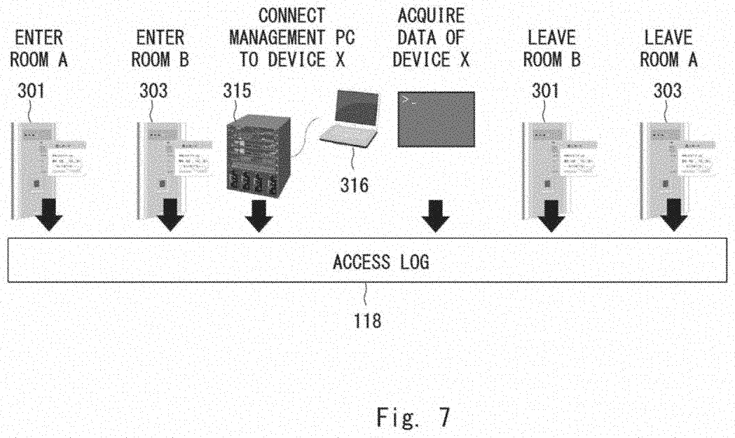

FIG. 7 shows a log stored in the log storage unit 118 as the action step advances. When the worker enters the room A through, for example, the door at which card reader 301 (refer to FIG. 6) is installed, the log acquisition unit 117 (refer to FIG. 2) acquires a log, which is output from the physical security apparatus 130, indicating that the worker enters the room A, and stores it in the log storage unit 118. Subsequently, when the worker enters the room B from the door at which the card reader 303 is installed, the log acquisition unit 117 acquires a log indicating such, which is output from the physical security apparatus 130, and stores it in the log storage unit 118.

The worker connects a management PC 316 to the device (device X) 315 after entering the room B. When the management PC 316 is connected to the port 1 enabled in accordance with the access control 162 (refer to FIG. 5), the cyber security apparatus 120 outputs a log indicating that the management PC is connected to the port 1 and this connection is permitted. The log acquisition unit 117 acquires the log and stores it in the log storage unit 118. When the worker connects the management PC 316 or the other PC to a port other than the port 1, the cyber security apparatus 120 outputs a log indicating that a PC is connected to a port other than the port 1 but this connection is denied. In this case, the log acquisition unit 117 stores the log indicating that the connection is denied in the log storage unit 118.

The worker executes the command Y to acquire data from the device 315 using the management PC 316. At this time, the cyber security apparatus 120 permits the execution of the command Y in accordance with the access control 163, and outputs a log indicating that the command Y is executed. The log acquisition unit 117 acquires the log and stores it in the log storage unit 118. When the worker attempt to execute a command other than the command Y, the cyber security apparatus 120 does not permit the execution and outputs a log indicating that the execution of the command is denied. In this case, the log acquisition unit 117 stores the log indicating that the execution of the command is denied in the log storage unit 118.

After the data acquisition, when the worker leave the room B thorough the door at which the card reader 303 is installed, the log acquisition unit 117 acquires a log, which is output from the physical security apparatus 130, indicating that the worker leave the room B, and stores it in the log storage unit 118. After that, the when the worker leave the room A, for example, thorough the door at which the card reader 301 is installed, the log acquisition unit 117 acquires a log output from the physical security apparatus 130 indicating that the worker leave room A and stores it in the log storage unit 118.

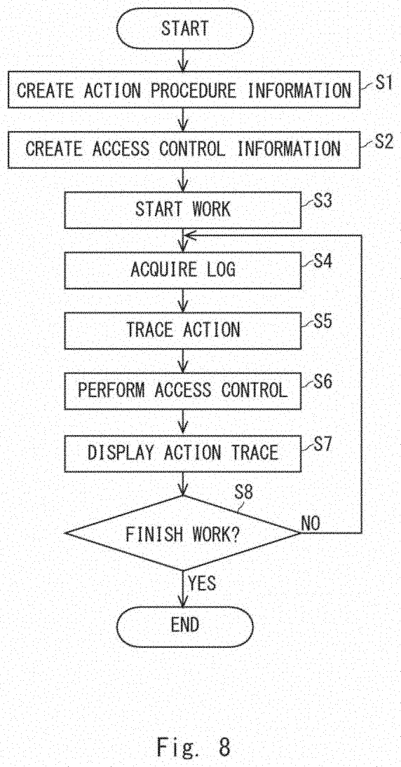

Next, an operation procedure will be described. FIG. 8 shows an operation procedure in the action monitoring of the worker. The supervisor or the like creates the action procedure information 112 in accordance with locations where the worker works and contents of the work (Step S1). Further, the supervisor creates the access control information 113 with respect to the cyber security apparatus 120 and the physical security apparatus 130 (Step S2). The supervisor creates the action procedure information 112 and the access control information 113, for example, via the above mentioned edit screen 200.

When the worker starts the work at the work start time (Step S3), the cyber security apparatus 120 and the physical security apparatus 130 output logs according to actions of the worker. It assumed that the access control unit 1116 causes the physical security apparatus 130 to execute the access control 161 shown in FIG. 5, when it is the scheduled work start. The log acquisition unit 117 acquires the logs from the cyber security apparatus 120 and the physical security apparatus 130, and stored the logs in the log storage unit 118 (Step S4). The action trace unit 114 traces action steps of the worker based on the action procedure information 112 and the log information stored in the log storage unit 118 (Step S5). The access control unit 116 executes the access control defined by the access control information 113 in accordance with the traced action steps (Step S6).

In Step S5, the action trace unit 114 traces which action step the worker advanced, for example, among the actin steps 151 to 156 shown in FIG. 5, based on the log information. In Step S6, the access control unit 116 executes the access control to be applied at the current action step in accordance with the relationship between the action steps and the access control shown in FIG. 5. The access control unit 116 executes the access control, for example, by issuing a command indicating the content of the access control included in the access control information 113 to the cyber security apparatus 120 and the physical security apparatus 130 in accordance with the advance of the action step.

The trace display unit 115 associates the action step with the log based on the log information and the advance of the action step of the worker traced in Step S5 and displays them on the display device 140 (Step S7). For example, in Step S7, the trace display unit 115 graphically displays the traced action step and a mark indicating that the log is generated, namely, access to the cyber security apparatus 120 or the physical security apparatus 130 is occurred. In this case, the trace display unit 115 may display a mark indicating that access corresponding to a log indicating the access is permitted is occurred and a mark indicating that access corresponding to a log indicating that the access is not permitted is occurred in different display manners.

The action trace unit 114 determines whether or not the work of the worker is finished, in other words, the work reaches the last action step of the series of action steps (Step S8). When it is determined that the work is not finished in Step S8, the process returns to Step S4, and the acquisition of the log is continued. When it is determined that the work is finished, the process is end. It should be noted that the timing of tracing the action step in Step S5 and the timing of displaying the trace in Step S7 are not particularly limited. Step S5 and Step S7 may be carried out in real time during the work of the worker, or after the work has finished.

For example, when it is the work start time, the access control 161 shown in FIG. 5 is executed, and the worker can enter the room A and the room B. When the worker enters the room A through authentication using the card reader 301 or 302, the physical security apparatus 130 outputs a log indicating that the associated door is unlocked. The action trace unit 114 advances the action step to the action step 151 in Step S5, based on the log indicating that the door is unlocked, which is acquired from the physical security apparatus 130.

Next, when the worker enters the room B through authentication using the card reader 303, the physical security apparatus 130 outputs a log indicating that the associated door is unlocked. The action trace unit 114 advances the action step from the action step 151 to the action step 152 based on the log indicating that the door leading to the room B is unlocked.

When the action step is advanced to the action step 152, the access control unit 116 causes the cyber security apparatus 120 to execute the access control 162 ‘enabling the port 1 of the device X’ in Step S6. The cyber security apparatus 120 executes the access control 162 to make the port 1 of the device X enable. When the worker connects a PC for working to the port 1 of the device X, the cyber security apparatus 120 outputs a log indicating that a management PC is connected to the port 1 of the device X. The trace display unit 115 associates a mark indicating that access is made to the cyber security apparatus 120 with a position of the action step 152, and graphically displays them in Step S7.

The action trace unit 114 determines, in Step S8, whether the work is finished or not. If the current action step is the action step 152, since the work is not finished, the process returns to Step S4 and a log is acquired. The action trace unit 114 advances the action step from the action step 152 to action step 153 based on the log, which is stored in the log storage unit 118, indicating that the management PC is connected to the port 1 of the device X,

When the action step is advanced to the action step 153, the access control unit 116 causes the cyber security 120 to executes the access control 163 ‘allowing execution of the command Y’, and causes the physical security apparatus 130 to execute the access control 165 ‘aiming the camera to the device X’ in Step S6. When the worker executes the command Y and acquires data from the device X, the cyber security apparatus 120 outputs a log indicating so. The trace display unit 115 associates a mark indicating that access is made to the cyber security apparatus 120 with a position of the action step 153 and graphically displays them in Step S7. In the same manner, trace of the action steps based on the logs and accompanying access control, and display of marks indicating the occurrence of logs are repeated until the work is finished.

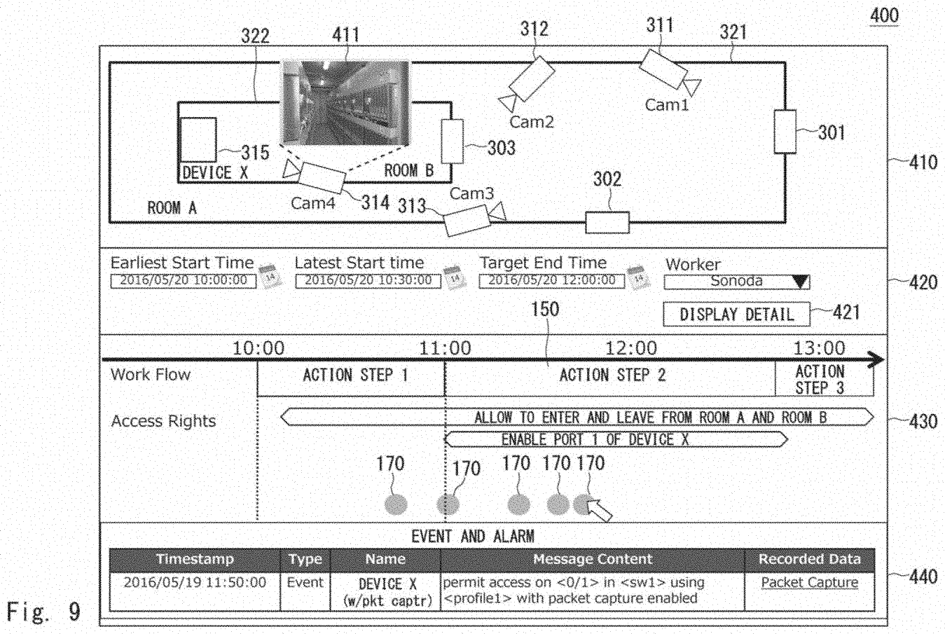

FIG. 9 shows an example of a screen (monitoring screen) displayed on the display device 140 during the action tracing (monitoring) is executed. A monitoring screen 400 shown in FIG. 9 includes roughly includes four areas 410, 420, 430, and 440. The area 410 is an area, like the area 210 of the edit screen 200 shown in FIG. 6, where arrangement of devices and the like is displayed. The supervisor may select the monitoring camera 314 in the area 410 using, for example, a pointing device such as a mouse. In that case, an image 411 recorded using the monitoring camera 314 is displayed in the area 410.

The area 420 is an area where information with respect to the work is displayed. The supervisor may causes the series of action steps of the worker and the access control applied in each action step to be graphically displayed by selecting a button 421 ‘display detail’.

The area 430 is an area where the advance of the action step and the executed access control are graphically displayed. In the area 430, for example, the advance of the action steps up to the current time, the content of the access control applied as the advance of the action step, and marks 170 indicating that access is made to the cyber security apparatus 120 and the physical security apparatus 130 are displayed along the time series. The user may select any time point during the work in the area 430. When the user selects a time point, the image 411 of the monitoring camera recorded at the selected time is displayed in the area 410.

The area 440 is an area where contents of logs are displayed. The supervisor may select the mark 170 displayed in the area 430 using a pointing device such as mouse. When the supervisor select a mark 170, the trace display unit 115 displays the content of the log of the selected mark. By referring to the content displayed in the area 440, the supervisor can check what kind of access is occurred to the cyber security apparatus 120 and the physical security apparatus 130.

Consecutively, an example of display of the area 430 when the worker performs a suspicious action. In the following description, it is assumed that the worker should act in accordance with the action procedure shown in FIG. 5. FIG. 10 shows a first example of a displayed screen. It is assumed that marks 170 shown in FIG. 10 are marks each indicating that the access is permitted, and marks 180 are marks each indicating that the access is denied. In the example shown in FIG. 10, the marks 170 are displayed during the action steps 151 and 152, and the supervisor referring to this screen can judge that the worker acts in regular action procedure.

However, in the action step 153, if execution of a command other than the command Y is attempted although the command Y permitted according to the access control 163 should be executed after the management PC is connected, the cyber security apparatus 120 outputs logs indicating that the access is denied. Two reasons, simply mistaking a command and attempting to execute a malicious command with malicious intent, are considered as reasons why the worker executes a command other than the command Y. When the worker attempts to execute a command multiple times because the execution of the command is not permitted, logs each indicating the access refusal are output for that number of times. In the action step 153, normally, the command Y is executed only once and thus one mark 170 is be displayed. However, if execution of a command other than command Y is attempted, multiple marks 180 are displayed

When a plurality of the marks 180 are continuously displayed in the action step 153, the supervisor can determine that the worker attempts to execute a command other than the command Y. Especially, the supervisor can easily judge that a normal operation is not done by setting the mark 180 indicating that the access is denied to be a mark different in shape and/or display color from the normal mark 170. By referring to a screen as such, the supervisor can detect a suspicious action of the worker in the action step 153.

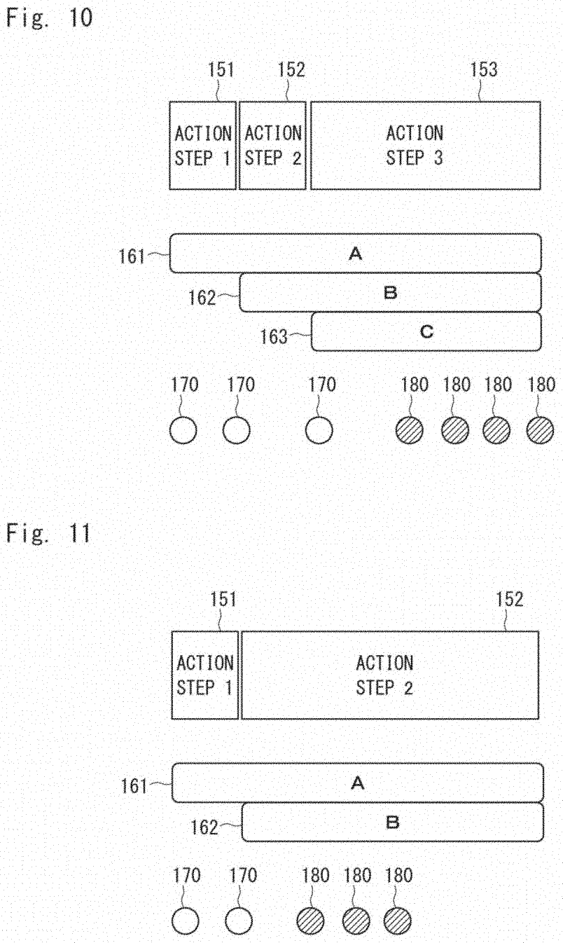

FIG. 11 shows a second example of a display screen. In this example, the marks 170 are displayed in the action step 151, and the supervisor who sees this screen can determine that the worker is acting a normal operation.

However, in the action step 152, after the worker enters the room B, when a PC is connected to a port other than the port 1 although the management PC should be connected to the port 1 enabled in accordance with the access control 162, the cyber security apparatus 120 outputs a log indicating that the access is denied. As the reason why the worker connects a PC to a port other than the port 1, the two reasons, simply the worker mistakes a connecting port or the worker maliciously attempts to connect a PC to an invalid port, are considered. When the worker attempts to connect a PC to a disable port in multiple times, logs indicating that the access is denied are output for that number of times. In action step 152, although the connection of the management PC to the port 1 should be carried out only once and thus only one mark 170 should be displayed, multiple marks 180 are displayed when a PC is connected to the other port.

The supervisor can determine that the worker attempts to connect a PC to a port other than a predetermined port when multiple marks 180 are continuously displayed in the action step 152. That is, the supervisor can judge that the worker do not act in accordance with the normal operation procedure. In this way, by referring to the screen shown in FIG. 11, the supervisor can detect a malicious action of the worker in the action step 152.

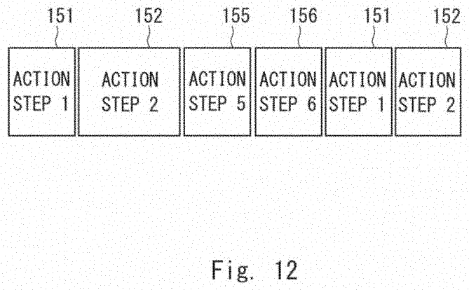

FIG. 12 is a third example of a display screen. In this example, although the worker acts within a range permitted in accordance with the access control 161, the action steps advance in an order different from the order defined by the action procedure information 112. That is, after entering the room B from the room A, the worker leaves the room B and the room A and enters the room A and room B again. In this case, as shown in FIG. 12, the fact that action steps are advancing in order of the action step 151, the action step 152, the action step 155, the action step 156, the action 151, and the action step 152 is displayed on the screen. The supervisor can have a doubt as to whether the worker have performed acts different from the original acts in the room B, and thus can detect a malicious action of the worker.

In the present embodiment, the supervisor generates the action instruction information including the action procedure information 112 and the access control information 113 and gives it to the action monitoring apparatus 110. The worker performs movement and works in accordance with the action procedure defined by the action procedure information 112. The action monitoring apparatus 110 acquires logs output by the cyber security apparatus 120 and the physical security apparatus 130, and stored them in the log storage unit 118. The action monitoring apparatus 110 sequentially compare the log information stored in the log storage unit 118 with the action procedure information 112 and the access control information 113, and graphically display the result of the comparison as an action trace of the worker.

In the present embodiment, the action monitoring apparatus 110 displays (visualize) a series of actions extending over the cyber security apparatus 120 and the physical security apparatus 130. Accordingly, the supervisor (monitor) can refer to the series of events of work activities extending over the both cyber and physical as a graphical action trace. Especially, the action monitoring apparatus 110 graphically displays the advance of the action steps of the worker and the access to the security apparatus as the action trace. By referring to the action trace and checking the advance of the action steps and the access to the security apparatus, the supervisor can visually compare the operation procedure that the worker should perform, which is pre-registered, with the actual action trace. In this way, it is possible to find, with respect to a worker to whom a legitimate ID is given, an action deviating from the action procedure or the access control as a malicious action.

Further, in the present embodiment, the access control unit 116 of the action monitoring apparatus 110 causes each of the cyber security apparatus 120 and the physical security apparatus 130 to perform the access control defined by the access control information 113 in accordance with the advance of the action steps. By doing so, it is possible to perform sequential access control during the work of the worker or in accordance with the work start/end time.

It should be noted that although an example in which the action monitoring system 100 includes both the cyber security apparatus 120 and the physical security apparatus 130 is explained in the above embodiment, the present disclosure is not limited thereto. It is possible to adopt a configuration in which the action monitoring system 100 includes any one of the cyber security apparatus 120 and the physical security apparatus 130. Further, the cyber security apparatus 120 and the physical security apparatus 130 do not necessarily configure a portion of the present system, and these security apparatuses may be operated as separate systems and log may be acquired from the separate systems.

In the above embodiment, although an example in which the action instruction information 111 includes the action procedure information 112 and the access control information 113, the action instruction information 111 may include at least the action procedure information 112, and may not include the access control information 113. In that case, the access control may be performed, for example, using the other system.

In the above embodiment, although an example in which the action step and the access to the security apparatus are arrange along the time series in the action trace, the present disclosure is not limited thereto. The action step and the access to the security apparatus may be arranged based on any cause-and-effect relationship, or based on a predetermined sequence.

In the above embodiment, although an example in which the trace display unit 115 displays the action trace for the supervisor is explained, it is possible for the trace display unit 115 to display action trace for the worker. For example, the trace display unit 115 may display action trace for the worker with a screen configuration different from that for the supervisor on the display device 140. For example, by displaying the history of the past action steps and the next action step for the worker, the worker can smoothly perform the work according to the action procedure.

In the above example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), Compact Disc Read Only Memory (CD-ROM), CD-R, CD-R/W, semiconductor memories (such as Mask ROM, Programmable ROM (PROM), Erasable PROM (EPROM), flash ROM, Random Access Memory (RAM)). Further, the program may be provided to a computer using any type of transitory computer readable media. Examples of transitory computer readable media include electrical signals, optical signals, and electromagnetic waves. Transitory computer readable media can provide a program to a computer via a wired communication path such an electrical wire and an optical fiber, or a wireless communication path.

Note that the present disclosure is not limited to the above-described embodiments, and modifications can be made as appropriate without departing from the scope of the present disclosure. Further, the present disclosure may be implemented by appropriately combining the respective embodiments.

For example, the whole or part of the exemplary embodiments disclosed above can be described as, but not limited to, the following supplementary notes.

### [Supplementary Note 1]

An action monitoring apparatus comprising:

an action trace unit for tracing, based on action instruction information including action procedure information which defines an action procedure of a person including a plurality of action steps and log information with respect to access to an object to be monitored, the log information being acquired from a security apparatus for monitoring the object to be monitored, advance of the action step in the action procedure; and

a trace display unit for associating the advance of the action step with access to the security apparatus based on the log information and the traced advance of the action step, and displaying them on a display device.

### [Supplementary Note 2]

The action monitoring apparatus according to supplementary note 1, wherein the trace display unit displays the advance of the action step and the access to security apparatus in chronological order.

### [Supplementary Note 3]

The action monitoring apparatus according supplementary note 1 or 2, wherein, when a log indicating specific access defined as a transition condition from an action step to another action step in the action procedure is included in the log information, the action trace unit shifts the action step to a next action step.

### [Supplementary Note 4]

The action monitoring apparatus according to any one of supplementary notes 1 to 3, wherein the trace display unit displays the action steps and a mark indicating that access is made.

### [Supplementary Note 5]

The action monitoring apparatus according to supplementary note 4, wherein, when the mark is selected, the trace display unit displays a content of a log corresponding to the selected mark.

### [Supplementary Note 6]

The action monitoring apparatus according to supplementary note 4 or 5, wherein the log information includes a log indicating that access is permitted and a log indicating that access is not permitted, and the trace display unit displays a mark indicating that access is made corresponding to the log indicating that access is permitted and a mark indicating that access is made corresponding to the log indicating that access is not permitted in different display manners.

### [Supplementary Note 7]

An action monitoring system comprising:

a security apparatus for monitoring an object to be monitored;

a log acquisition unit for acquiring log information with respect to access to the object to be monitored from the security apparatus;

an action trace unit for tracing, based on the log information and action instruction information including action procedure information which defines an action procedure of a person including a plurality of action steps, advance of the action step in the action procedure; and

a trace display unit for associating the advance of the action step with access to the security apparatus and displaying them on a display device.

### [Supplementary Note 8]

The action monitoring system according to supplementary note 7, wherein the action instruction information further includes access control information which defines access control in the security apparatus, and

the action monitoring system further comprises an access control unit for performing access control based on the advance of the action step and the access control information.

### [Supplementary Note 9]

The action monitoring system according to supplementary note 8, wherein the access control information includes information associating a content of the access control with the action step in which the content of the access control is applied.

### [Supplementary Note 10]

The action monitoring system according to supplementary note 9, wherein the access control unit issues a command indicating the content of the access control included in the access control information to the security apparatus in accordance with the advance of the action step.

### [Supplementary Note 11]

The action monitoring system according to any one of supplementary notes 7 to 10, wherein the security apparatus includes at least one of a cyber security apparatus and a physical security apparatus.

### [Supplementary Note 12]

The action monitoring system according to any one of supplementary notes 7 to 11, wherein the trace display unit displays the advance of the action step and the access to the security apparatus in chronological order.

### [Supplementary Note 13]

The action monitoring system according to any one of supplementary notes 7 to 12, wherein, when a log indicating specific access defined as a transition condition from an action step in the action procedure to another action step is included in the log information, the action trace unit shifts the action step to a next action step.

### [Supplementary Note 14]

The action monitoring system according to any one of supplementary notes 7 to 13, wherein the trace display unit displays the action steps and a mark indicating that access is made.

### [Supplementary Note 15]

The action monitoring system according to supplementary note 14, wherein, when the mark is selected, the trace display unit displays a content of a log corresponding to the selected mark.

### [Supplementary Note 16]

An action monitoring method comprising:

acquiring log information with respect to access to an object to be monitored from a security apparatus for monitoring the object to be monitored;

tracing, based on the log information and action instruction information including action procedure information which defines an action procedure of a person including a plurality of action steps, advance of the action step in the action procedure; and

associating the advance of the action step with access to the security apparatus and displaying them on a display device.

### [Supplementary Note 17]

A program for causing a computer to execute steps of:

acquiring log information with respect to access to an object to be monitored from a security apparatus for monitoring the object to be monitored;

tracing, based on the log information and action instruction information including action procedure information which defines an action procedure of a person including a plurality of action steps, advance of the action step in the action procedure; and

associating the advance of the action step with access to the security apparatus and displaying them on a display device.

### REFERENCE SIGNS LIST

10: ACTION MONITORING APPARATUS
11: ACTION TRACE UNIT
12: ACTION INSTRUCTION INFORMATION
13: ACTION PROCEDURE INFORMATION
14: TRACE DISPLAY UNIT
16: SUPPLEMENTARY NOTE
17: SUPPLEMENTARY NOTE
20: DISPLAY DEVICE
100: ACTION MONITORING SYSTEM
110: ACTION MONITORING APPARATUS
111: ACTION INSTRUCTION INFORMATION
112: ACTION PROCEDURE INFORMATION
113: ACCESS CONTROL INFORMATION
114: ACTION TRACE UNIT
115: TRACE DISPLAY UNIT
116: DYNAMIC ACCESS CONTROL UNIT
117: LOG ACQUISITION UNIT
118: LOG STORAGE UNIT
120: CYBER SECURITY APPARATUS
130: PHYSICAL SECURITY APPARATUS
140: DISPLAY DEVICE
150-156: ACTION STEPS
160-166: ACCESS CONTROL
170, 180: MARK
200: EDIT SCREEN
210, 220, 230, 240: AREA
221, 222: BUTTON
301-303: CARD READER
311-314: MONITORING CAMERA
315: DEVICE
316: MANAGEMENT PC
321, 322: ROOM
400: MONITORING SCREEN
410, 420, 430, 440: AREA
411: IMAGE
421: BUTTON

1. An action monitoring system comprising:
at least one memory storing instructions; and
at least one processor connected to the at least one memory and configured to execute the instructions to:
acquire log information with respect to access to a monitoring target from each of a physical security apparatus and a cyber security apparatus;
trace advance of an action step in an action procedure, based on the acquired log information and action instruction information including action procedure information which defines the action procedure of a worker including a plurality of action steps; and
perform an access control, based on an access control information associating a content of access control to each of the physical security apparatus and the cyber security apparatus to the action step in which the content of the access control is applied, to each of the physical security apparatus and the cyber security apparatus in accordance with the advance of the action step of the worker.

2. The action monitoring system according to claim 1, wherein
the physical security apparatus includes a monitoring camera, and
the at least one processor is configured to execute the instruction to issue a command indicating the content of the access control, which controls a photographing direction of the monitoring camera, to the physical security apparatus in accordance with the advance of the action step of the worker.

3. The action monitoring system according to claim 1, wherein
the physical security apparatus includes a system for controlling locking and unlocking of a door in accordance with a result of authentication by a card reader installed at a doorway of a room, and
the at least one processor is configured to execute the instruction to issue a command indicating the content of the access control, which controls locking and unlocking of the door in accordance with the result of authentication the worker, to the physical security apparatus in accordance with the advance of the action step of the worker.

4. The action monitoring system according to claim 1, wherein
the cyber security apparatus is configured to control access to a monitored device, and
the at least one processor is configured to execute, when a terminal device of the worker is connected to a port allowed to connect, the instructions to:
issue a command indicating the content of the access control which the terminal device of the worker is permitted to access the monitored device to the cyber security apparatus; and
output a log indicating that the terminal device of the worker is permitted to access the monitored device.

5. The action monitoring system according to claim 1, wherein
the cyber security apparatus includes a mechanism for controlling access a monitored device, and
the at least one processor is configured to execute, when a terminal device of the worker is connected to a port not allowed to connect, the instructions to:
issue a command indicating the content of the access control which the terminal device of the worker is not permitted to access the monitored device to the cyber security apparatus; and
output a log indicating that the terminal device of the worker is not permitted to access the monitored device.

6. The action monitoring system according to claim 1, wherein
the physical security apparatus includes a monitoring camera and a system for controlling locking and unlocking of a door in accordance with a result of authentication by a card reader installed at a doorway of a room,
the cyber security apparatus is configured to control access to a monitored device, and
the at least one processor is configured to execute, in accordance with the advance of the action step of the worker, the instructions to issue
a command indicating the content of the access control, which controls a photographing direction of the monitoring camera, to the physical security apparatus and
a command indicating the content of the access control, which controls locking and unlocking of the door in accordance with the result of authentication the worker, to the physical security apparatus in accordance with the advance of the action step of the worker,
a command indicating the content of the access control to the cyber security apparatus, when a terminal device of the worker is connected to a port of a monitored device, according to an access authority to the port of the monitored device.

7. An action monitoring method comprising:
acquiring log information with respect to access to a monitoring target from each of a physical security apparatus and a cyber security apparatus;
tracing advance of an action step in an action procedure, based on the acquired log information and action instruction information including action procedure information which defines the action procedure of a worker including a plurality of action steps; and
performing the access control, based on an access control information associating a content of access control to each of the physical security apparatus and the cyber security apparatus to the action step in which the content of the access control is applied, to each of the physical security apparatus and the cyber security apparatus in accordance with the advance of the action step of the worker.

8. The action monitoring system according to claim 7, comprising
issuing a command indicating the content of the access control, which controls a photographing direction of a monitoring camera, to the physical security apparatus in accordance with the advance of the action step of the worker.

9. The action monitoring system according to claim 7, comprising
issuing a command indicating the content of the access control, which controls a locking and unlocking of a door in accordance with the result of authentication the worker, to the physical security apparatus in accordance with the advance of the action step of the worker.

10. The action monitoring system according to claim 7, comprising:
when a terminal device of the worker is connected to a monitored device via a port allowed to connect,
issuing a command indicating the content of the access control which the terminal device of the worker is permitted to access the monitored device to the cyber security apparatus; and
outputting a log indicating that the terminal device of the worker is permitted to access the monitored device.

11. The action monitoring system according to claim 7, comprising:
when a terminal device of the worker is connected to a monitored device via a port not allowed to connect,
issuing a command indicating the content of the access control which the terminal device of the worker is not permitted to access the monitored device to the cyber security apparatus; and
outputting a log indicating that the terminal device of the worker is not permitted to access the monitored device.

12. The action monitoring system according to claim 7, comprising
issuing, in accordance with the advance of the action step of the worker,
a command indicating the content of the access control, which controls a photographing direction of a monitoring camera, to the physical security apparatus,
a command indicating the content of the access control, which controls locking and unlocking of the door in accordance with the result of authentication the worker, to the physical security apparatus in accordance with the advance of the action step of the worker, and
a command indicating the content of the access control to the cyber security apparatus, when a terminal device of the worker is connected to a port of a monitored device, according to an access authority to the port of the monitored device.

13. A non-transitory computer-readable recording medium that records a program causing a computer to execute:
processing of acquiring log information with respect to access to a monitoring target from each of a physical security apparatus and a cyber security apparatus;
processing of tracing advance of an action step in an action procedure, based on the acquired log information and action instruction information including action procedure information which defines the action procedure of a worker including a plurality of act ion steps; and
processing of performing the access control, based on an access control information associating a content of access control to each of the physical security apparatus and the cyber security apparatus to the action step in which the content of the access control is applied, to each of the physical security apparatus and the cyber security apparatus in accordance with the advance of the action step of the worker.

14. The non-transitory computer-readable recording medium according to claim 13, wherein the program causes a computer to further execute
processing of issuing a command indicating the content of the access control, which controls a photographing direction of a monitoring camera, to the physical security apparatus in accordance with the advance of the action step of the worker.

15. The non-transitory computer-readable recording medium according to claim 13, wherein the program causes a computer to further execute
processing of issuing a command indicating the content of the access control, which controls a locking and unlocking of a door in accordance with the result of authentication the worker, to the physical security apparatus in accordance with the advance of the action step of the worker.

16. The non-transitory computer-readable recording medium according to claim 13, wherein the program causes a computer to further execute, when a terminal device of the worker is connected to a monitored device via a port allowed to connect:
processing of issuing a command indicating the content of the access control which the terminal device of the worker is permitted to access the monitored device to the cyber security apparatus; and
processing of outputting a log indicating that the terminal device of the worker is permitted to access the monitored device.

17. The non-transitory computer-readable recording medium according to claim 13, wherein the program causes a computer to further execute, when a terminal device of the worker is connected to a monitored device via a port not allowed to connect,
processing of issuing a command indicating the content of the access control which the terminal device of the worker is not permitted to access the monitored device to the cyber security apparatus; and
processing of outputting a log indicating that the terminal device of the worker is not permitted to access the monitored device.

18. The non-transitory computer-readable recording medium according to claim 13, wherein the program causes a computer to further execute
processing of issuing, in accordance with the advance of the action step of the worker,
a command indicating the content of the access control, which controls a photographing direction of a monitoring camera, to the physical security apparatus,
a command indicating the content of the access control, which controls locking and unlocking of the door in accordance with the result of authentication the worker, to the physical security apparatus in accordance with the advance of the action step of the worker, and
a command indicating the content of the access control to the cyber security apparatus, when a terminal device of the worker is connected to a port of a monitored device, according to an access authority to the port of the monitored device.
